(19) United States
(12) Patent Application Publication
(10) Pub. No.: US 2010/0024307 A1
(43) Pub. Date: Feb. 4, 2010

(54) SECURITY GATE APPARATUS

(75) Inventors: Gerald Dale, Stoke-on-Trent (GB); Wayne Brian Woolridge, Stoke-0n-Trent (GB)

Correspondence Address: CHERNOFF, VILHAUER, MCCLUNG & STENZEL, LLP, 601 SW Second Avenue, Suite 1600, Portland, OR, 97204, US

(73) Assignee: BARKERS ENGINEERING LIMITED, Solihull (GB)

(21) Appl. No.: 12/526,658

(22) PCT Filed: Feb. 13, 2008
(86) PCT No.: PCT/GB08/00487

§ 371 Date: Aug. 13, 2009

(30) Foreign Application Priority Data
Feb. 15, 2007 (GB) 0702935.8

(51) Int. Cl. E01F 13/04; E05D 15/06; E05F 15/00; E06B 11/04

(52) U.S. Cl. 49/360; 49/404; 49/425

(57) ABSTRACT

A security gate apparatus (10) with first and second buttress assemblies (12, 14) and a barrier member (16) slidably movable along the track 68 between a closed position extending between the assemblies (12, 14), and an open position clear of the assembly (14). Each assembly (12, 14) includes upstanding members (18, 20, 54, 56) connected respectively by a link member (22), with at least some of the members (18, 20, 54, 56 and 22) being filled in use by concrete. The gate being locatable respectively between the upstanding members (18 and 20) and the upstanding members (54, 56).

This invention concerns improvements in or relating to Security Gate Apparatus.

Increasingly it is becoming necessary to protect particular buildings, areas or institutes with high impact gates. Such gates are intended to withstand large impacts, such as a vehicle being driven directly at them. A number of such gates have been proposed previously, but these have generally not been wholly satisfactory.

According to the present invention there is provided Security Gate Apparatus, the apparatus comprising first and second buttress assemblies locatable respectively on either side of an entrance, a barrier member slidably moveable relative to the buttress assemblies between a closed position extending between the first and second buttress assemblies, and an open position extending from the first buttress assembly away from the second buttress assembly, the buttress assemblies each comprising outer and inner upstanding members with a link member extending between lower parts thereof, the barrier member being transversely slidably moveable between the respective outer and inner upstanding members of each buttress assembly.

The outer and inner upstanding members may be hollow, and may be at least partially filled with concrete or another ballast material. Removable lids may be provided on the upstanding members to permit filling thereof. The link member may be hollow and may be at least partially filled with concrete or another ballast material.

In one embodiment the outer and inner upstanding members of the second buttress assembly are substantially filled with concrete or another ballast material, and the outer upstanding member and the link member of the first buttress assembly are substantially filled with concrete or another ballast material, whilst the inner upstanding member of the first buttress assembly is partially filled with concrete or another ballast material.

A track may extend from the first buttress assembly away from the second buttress assembly, and engagement means may be provided on the barrier member slidably engagable with the track.

Abutment members may be provided on the buttress assemblies to substantially prevent the barrier member moving upwardly upon impact thereto. The abutment member may comprise strips locatable above parts of the barrier member.

A drive means may be provided in the inner upstanding member of the first buttress assembly, engagable with the barrier member to cause sliding movement thereof. The drive means may be engagable with a toothed rack on the inner side of the barrier member. The toothed rack may be provided spaced from the top and bottom of the barrier member. The drive means may be mounted on the first buttress assembly such that in the event of an impact on the apparatus, limited relative movement is permitted between the drive means and the first buttress assembly.

Guide means may be provided on the upstanding members against which the barrier member is movably engagable, and the guide means may be deformable in the event of an impact against the apparatus. The guide means may be in the form of rollers. The guide means may be made of a deformable plastics material such as polyethanol.

Impact absorption means may be provided on the outer side of the barrier member, and may be provided spaced between the top and bottom of the barrier member. The impact absorption means may comprise a hollow member extending transversely across the barrier member.

Embodiments of the present invention will now be described by way of example only, and with reference to the accompanying drawings, in which:

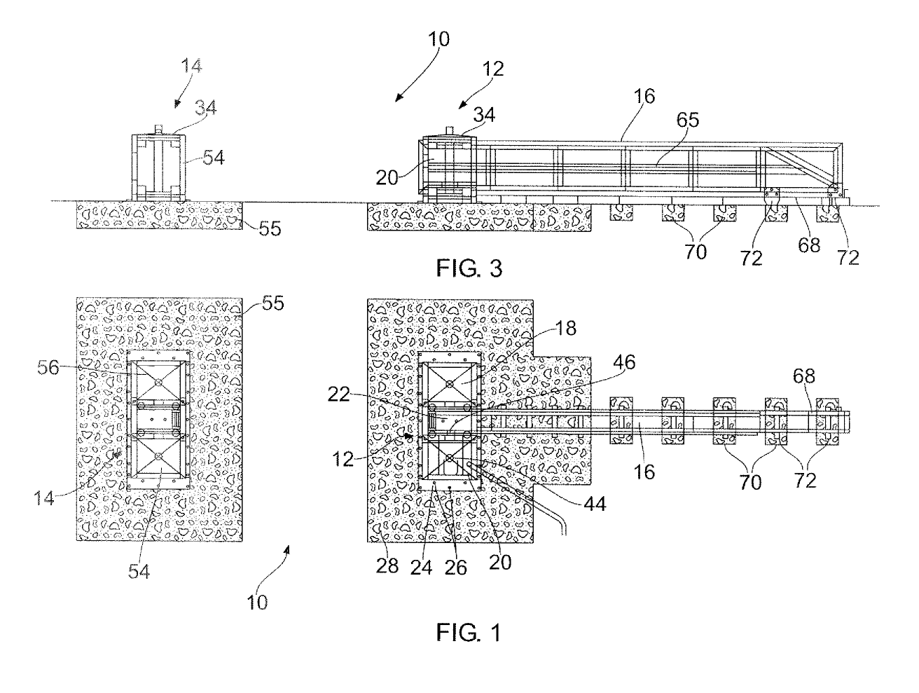

FIG. 1 is a diagrammatic plan view of a first Security Gate Apparatus according to the invention in an open condition;

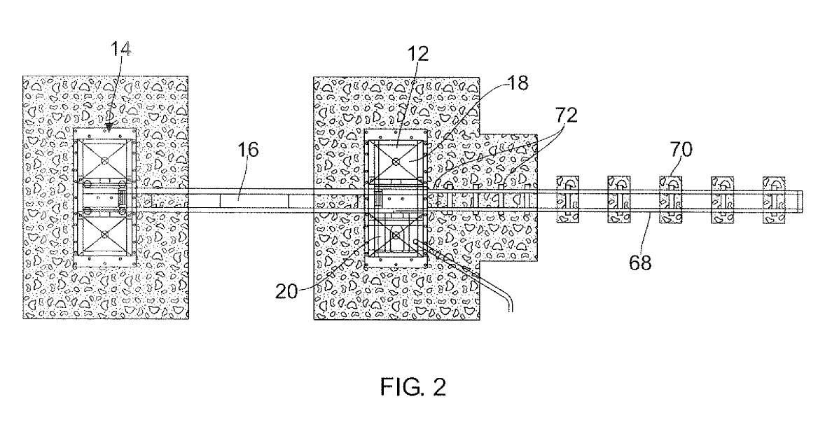

FIG. 2 is a similar view to FIG. 1 but in a closed condition;

FIG. 3 is a side view of the apparatus of FIG. 1 in an open condition;

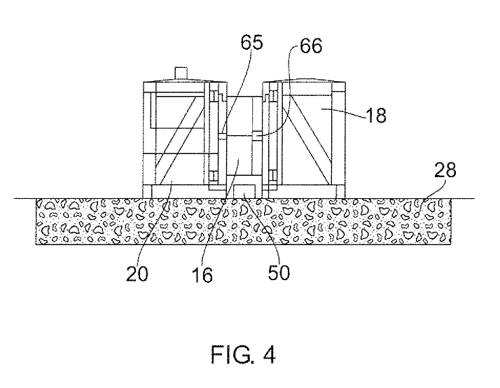

FIG. 4 is an end view of the apparatus of FIG. 1 in a closed condition;

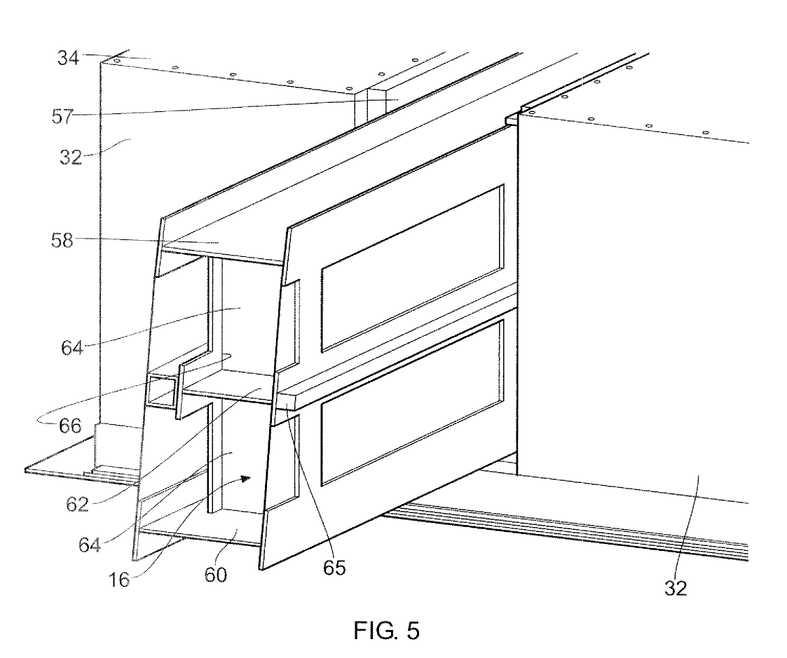

FIG. 5 is a diagrammatic perspective view of part of the apparatus of FIG. 1 in a partially open position;

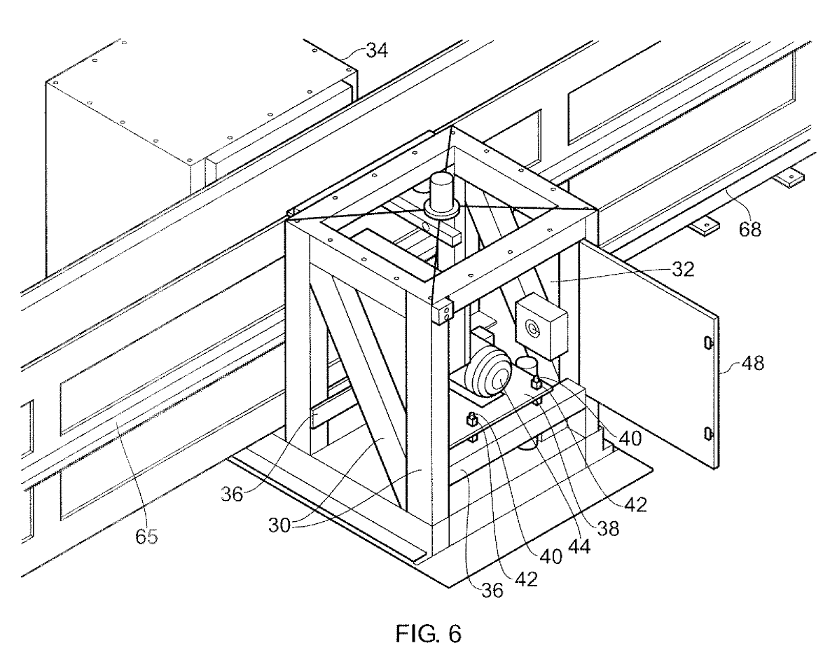

FIG. 6 is a diagrammatic partially cut away view of part of the apparatus of FIG. 1 in a partially open condition;

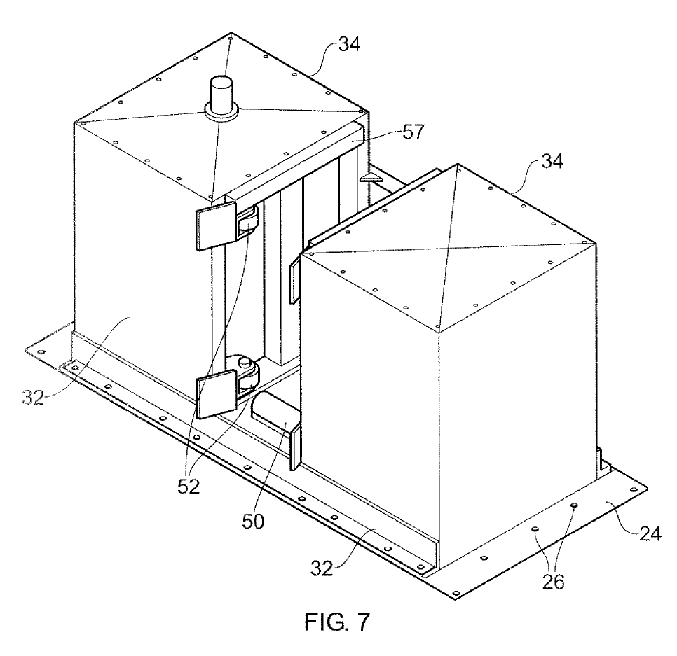

FIG. 7 is a diagrammatic perspective view of part of the apparatus of FIG. 1, but with some components omitted;

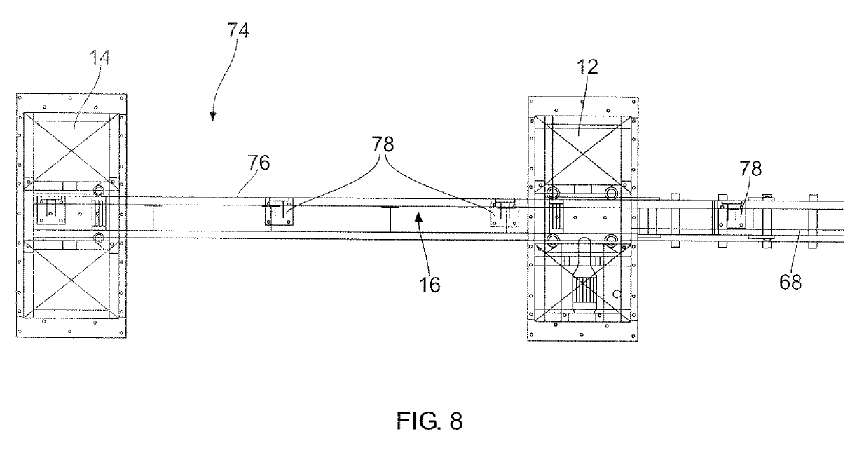

FIG. 8 is a diagrammatic plan view of a second Security Gate Apparatus according to the invention in a closed condition, and;

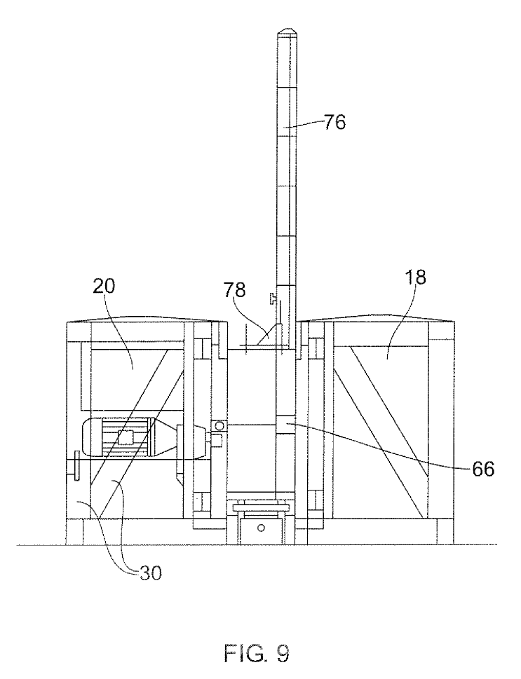

FIG. 9 is a diagrammatic end view of the apparatus of FIG. 8 in a closed condition.

FIGS. 1 to 7 show a security gate apparatus 10 comprising first and second buttress assemblies 12, 14, and a barrier member 16. The first buttress assembly 12 includes outer and inner upstanding members 18, 20 connected at their lower end by a link member 22. The upstanding members 18, 20 and link member 22 are mounted on a plate 24 with a plurality of holes 26 around its periphery to permit mounting to a concrete footing 28.

Both of the upstanding members 18, 20 have a frame 30 with outer side walls 32 provided thereon, and selectively removable lids 34. The outer upstanding member 18 in use will be full of concrete. The link member 22 is in the form of a hollow chamber which will also be filled in use with concrete.

The inner upstanding member 20 has two pieces of angle iron 36 spaced above the bottom thereof, and concrete will be provided in the inner upstanding member 20 up to the level of the angle iron 36. A frame member is mounted to the member 20 by bolts 40 extending between the two pieces of angle iron 36. The bolts 40 extend through slots 42 in the frame member 38 to enable limited relative movement therebetween in the event of an impact against the apparatus 10.

A motor 44 is mounted on the frame member 38. The motor 44 drives a cog 46. As is shown in FIG. 6 an inspection door 48 may be provided on the inner upstanding member 20 to permit access to the motor 44 and any control equipment therefor. A roller assembly 50 is provided on the link member 22 towards the left hand end thereof as shown in the drawings, for the barrier member 16 to move over. Guide rollers 52 are provided on the inside of the abutment members 18, 20 at lower and upper ends thereof aligned with the roller assembly 50.

The second buttress assembly 14 has a similar configuration to the first buttress assembly 12, except that in this instance the inner upstanding member 54 is similar to the outer upstanding member 56, which are both similar to the outer upstanding member 18. The assembly 14 is mounted on a concrete footing 55 in a similar manner. Abutment members in the form of rigid strips 57 are provided on the inside faces of the upstanding members 18, 20, 54, 56 immediately above the path of the barrier member 16 to present the barrier member 16 moving upwardly upon an impact thereagainst.

The barrier member 16 is formed from upper and lower transverse I beams 58, 60 forming the top and bottom thereof, with an intermediate smaller transverse I beam 62 substantially midway therebetween. A plurality of spaced lengths 64 of I beam extend vertically to interconnect the beams 58, 60, 62. A drive rack 65 is engagable with the cog 46 is provided on the inner face of the smaller I beam 62. An impact absorbing member in the form of a length of square section tube 66 is provided on the outer face of the I beam 62.

A track 68 extends from the first buttress assembly 12 away from the second buttresses assembly 14. The far end of the track 68 is mounted on individual concrete footings 70. A pair of rollers 72 are provided on the underside of the barrier member 16 towards the right hand end thereof as shown, which are movably engagable with the track 68. The various rollers described are made of stainless steel to avoid corrosion.

FIGS. 8 and 9 show a further Security Gate Apparatus 74 which is similar to the apparatus 10 except that a mesh fence 76 is mounted on top of the barrier member 16 by spaced brackets 78, to extend vertically therefrom.

In use the apparatus 10, 74 can operate as follows. In an open position as shown in FIGS. 1 and 3, the rollers 72 on the barrier member 16 are located at the right hand end of the track 68 as shown. To close the apparatus 10, 74 the motor 44 is activated to rotate the cog 46, which engages with the rack 64 to move the barrier member 16 to the left as shown in the drawings. Once fully closed the ends of the barrier member 16 will be between the respective upstanding members 18, 20, 54, 56 of the buttress assemblies 12, 14.

If an impact is received on the barrier member 16 this will be transferred to the buttress assemblies 12, 14, enabling a very high impact to be received without failure of the barrier member 16. This high performance results from a number of features. For instance, concrete is supplied into both of the upstanding members 18,20, 54, 56, and also the link member 22, thereby providing a very strong base. The tube 66 absorbs a significant amount of the impact. The impact is also absorbed by deformation of the guide rollers 52.

Various modifications may be made without departing from the scope of the invention. For instance the buttress members may have a different shape. As shown in FIGS. 8 and 9, it may be required to provide a fence on the barrier member.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Security gate apparatus, the apparatus comprising first and second buttress assemblies locatable respectively on either side of an entrance, a barrier member slidably moveable relative to the buttress assemblies between a closed position extending between the first and second buttress assemblies, and an open position extending from the first buttress assembly away from the second buttress assembly, the buttress assemblies each comprising outer and inner upstanding members with a link member extending between lower parts thereof, the barrier member being transversely slidably moveable between the respective outer and inner upstanding members of each buttress assembly.

2. Apparatus according to claim 1, in which the outer and inner upstanding members are hollow.

3. Apparatus according to claim 2, in which the outer and inner upstanding members are at least partially filled with concrete or another ballast material.

4. Apparatus according to in claim 2, in which removable lids are provided on the upstanding members to permit filling thereof.

5. Apparatus according to claim 1, in which the link member is hollow.

6. Apparatus according to claim 5, in which the link member is at least partially filled with concrete or another ballast material.

7. Apparatus according to claim 6, in which the outer and inner upstanding members of the second buttress assembly are substantially filled with concrete or another ballast material, and the outer upstanding member and the link member of the first buttress assembly are substantially filled with concrete or another ballast material, whilst the inner upstanding member of the first buttress assembly is partially filled with concrete or another ballast material.

8. Apparatus according to claim 1, in which a track extends from the first buttress assembly away from the second buttress assembly.

9. Apparatus according to claim 8, in which engagement means is provided on the barrier member slidably engagable with the track.

10. Apparatus according to claim 1, in which abutment members are provided on the buttress assemblies to substantially prevent the barrier member moving upwardly upon impact thereto.

11. Apparatus according to claim 10, in which the abutment member comprise strips locatable above parts of the barrier member.

12. Apparatus according to claim 1, in which a drive means is provided in the inner upstanding member of the first buttress assembly, engagable with the barrier member to cause sliding movement thereof.

13. Apparatus according to claim 12, in which the drive means is engagable with a toothed rack on the inner side of the barrier member.

14. Apparatus according to claim 13, in which the toothed rack is provided spaced from the top and bottom of the barrier member.

15. Apparatus according to claim, 12 in which the drive means is mounted on the first buttress assembly such that in the event of an impact on the apparatus, limited relative movement is permitted between the drive means and the first buttress assembly.

16. Apparatus according to claim 1, in which guide means is provided on the upstanding members against which the barrier member is movably engagable.

17. Apparatus according to claim 16, in which the guide means is deformable in the event of an impact against the apparatus.

18. Apparatus according to claim 17, in which the guide means is made of a deformable plastics material such as polyethanol.

19. Apparatus according to claim 16, in which the guide means is in the form of rollers.

20. Apparatus according to claim 1, in which impact absorption means is provided on the outer side of the barrier member.

21. Apparatus according to claim 20, in which impact absorption means is provided spaced between the top and bottom of the barrier member.

22. Apparatus according to claim 20, in which the impact absorption means comprises a hollow member extending transversely across the barrier member.

23-24. (canceled)
